(19) United States
(12) Patent Application Publication
(10) Pub. No.: US 2009/0065484 A1
(43) Pub. Date: Mar. 12, 2009

(54) Welding polymeric panels to metal surfaces

(75) Inventors: Pei-Chung Wang, Troy, MI (US); Joseph J. Speranza, Rochester Hills, MI (US); John D. Fickes, Brighton, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/853,890

(22) Filed: Sep. 12, 2007

(51) Int. Cl. B23K 11/16

(52) U.S. Cl. 219/118

(57) ABSTRACT

A joining portion of a polymeric component, such as a vehicle door panel, may be welded (for example, a spot weld) to a metal component, such as a mating vehicle panel, using a molded-in-place metallic welding insert. The welding insert is shaped to provide welding surfaces at both surfaces of the joining portion of the plastic component and to conduct a welding current between the surfaces. When the workpieces are assembled for welding, opposing spot welding electrodes bear against the outer surfaces of the metal part and the metal insert in the plastic part. A spot welding operation produces a weld nugget between the facing surface of the metal part and the metal insert anchored in the plastic part. Continuous seam welds or a series of stitch seam welds may be made using suitably shaped welding inserts.

### TECHNICAL FIELD

This invention pertains to methods for attaching a polymeric article, like a fiber reinforced polymer automotive vehicle body panel, to a metal surface, for example a surface on another vehicle panel or on a body frame member.

### BACKGROUND OF THE INVENTION

It is often desirable or necessary to join polymeric body members to each other or to metal body members in the construction of automotive vehicle bodies. Various materials combinations are specified to obtain suitable component strength and reduced weight. Vehicle closure members such as doors, deck lids and tailgates often comprise mating inner and outer panels that are attached to each other at peripheral flange surfaces or at beltline surfaces. In other body structures a panel member may be attached, for example, to a space frame structure or other body structure, or a composite floor pan may be attached to a steel underbody assembly. When the members to be attached are both made of the same metal or of polymeric material they usually can be hemmed and welded or adhesively bonded by known practices. But when a polymeric member is to be attached to a metal member the attachment options are more limited.

Polymeric body members may include members molded of thermoplastic or thermoset polymer compositions. Often the liquid polymeric precursor materials are mixed with fibers of glass or carbon or other reinforcing material. Sometimes the reinforcing material is in the form of layers of cloth or mats of the fiber material. Examples of such moldable materials include mats of glass fibers infiltrated with a styrene-unsaturated polyester composition (FRP) or cloths of carbon fibers embedded in a matrix polymer material (sometimes called carbon composites).

Many steel alloys are available for the stamping of door panels or the welding of body structures. Aluminum alloys and magnesium alloys are also available for forming body panels and other body structures.

Sophisticated fixturing equipment and computer controlled robotic resistance welding equipment and adhesive application equipment are available for constructing vehicle bodies. While metal panels and polymeric panels may be adhesively bonded there is a need for a method for welding electrically non-conductive polymeric components to metal components.

### SUMMARY OF THE INVENTION

In one embodiment of the invention, a glass fiber reinforced polymer vehicle door panel is welded to a carbon steel alloy door panel. The polymeric panel may be the outer panel which is shaped to define a portion of the outer visible surface of the vehicle including a window opening. The outer panel is often molded to have peripheral flange portions for attachment to complementary flange portions of an inner panel. The steel inner panel is shaped (for example, stamped) to be attached to the outer panel and provide a compartment between the panels for enclosing window operating mechanisms and door closing mechanisms and the like. In addition to its peripheral flanges the inner panel may also have a bonding surface below the window opening for further attachment to the outer panel. An object of this invention is to prepare a molded polymeric part or panel for a series of spot weld or seam weld connections to the metal panel or other metal workpiece.

In accordance with an embodiment of the invention, metallic welding body inserts are designed and made for incorporation in a molded polymeric body panel or other component. Such polymeric components typically have a body portion, such as a relatively thin-wall flange, that is shaped and located for attachment to another panel or structural body member. The flange has a surface (often a flat surface) for placement against a complementary surface of an attachment portion of another panel or body structure. The thickness of the flange or other connecting portion contributes to the structural integrity of the attached components. The thickness of the attachment portions also permit attachment of the components by electrical resistance welding.

The metallic welding inserts are designed for incorporation into the flange region (or other intended attachment portion) of the panel. For example, the welding inserts may be incorporated as the panel is being molded, or they may be mechanically inserted into a panel. The welding bodies have a height dimension (or longitudinal direction) based on the thickness of the flange or other connecting portion of the panel. The top and bottom surfaces of the welding body lie near or above the surface of the flange. One surface of the welding body provides welding contact area for the formation of a welded bond with a mating part. And the other surface of the welding body provides a contact surface for an electrical resistance welding electrode. The top and bottom welding surfaces of the welding body may be sized and shaped for a spot weld, a continuous seam weld, a stitch seam weld or other weld pattern. The size of the top and bottom surfaces is determined such that welding electrodes may be readily aligned with one of the surfaces and a welding current passed through the insert with minimal damage to the surrounding polymeric workpiece. The body portion of the metallic welding body has sufficient cross-sectional area for conduction of a resistance welding current and the body may also be shaped to suitably anchor the welding insert in surrounding reinforced polymer material. The metal composition of the welding insert may be the same as the metal panel or complementary to its composition for producing a strong welded bond. Several of the welding inserts may be molded into the polymeric component for providing attachment of the panels. In many embodiments of the invention, the top and bottoms surfaces of the inserts are alike for easy placement of the inserts for molding.

In some embodiments of the invention it may be desirable to coat the metallic insert with a thermally insulating material, such as a ceramic powder, to reduce the conduction of heat from the welding step into the adjacent polymeric material. For example, a powder mixture of about eighty percent by weight alumina (Al₂O₃) and twenty percent silica (SiO₂) may be dispersed in water or other liquid vehicle, the dispersion applied to the inserts, and the liquid evaporated to leave an insulating coating.

Thus, in an embodiment of the invention, a precursor mix for the molding of a fiber reinforced polymeric panel is prepared for charging to a suitable molding tool. A suitable number of the welding inserts may be placed in the mold and the fluid precursor material injected or charged into the cavity of the mold. The composition of the welding inserts is compatible for resistance welding with the composition of the metal component to be attached. For example, the metal insert is formed of an alloy of the same base metal as the metal component, i.e., both of ferrous alloys or both of aluminum alloys. The mobile precursor material flows or is placed around the welding inserts and the inserts are suitably located and anchored in the molded component when the moldable charge is cured. Any necessary further processing of the polymeric component is then completed.

The polymeric component is assembled and fixtured with a metal component for joining by electrical resistance welding. The surfaces of the metallic welding inserts are placed against the weld site areas of the metal component. Optionally, an adhesive film may be applied between the contacting surfaces of the polymeric and metal components to complement the welded connections. Following placement of the components for welding, one or more electrical resistance welds are formed simultaneously or progressively at the intended weld sites. For example, opposing spot welding electrodes are brought to bear on opposite sides of the assembled parts with one electrode bearing against one surface of a welding insert and the opposing electrode bearing on the opposite side of the metal part. A momentary welding current is passed through the welding insert and contacting metal part to fuse the anchored metal insert to the metal part. In other embodiments, a seam weld or series of seam welds may be formed using suitable combinations of welding electrodes.

The connections between the polymeric part and metal part may solely comprise welded connections or a combination of welded connections and adhesive bonding or other means of attachment. In some embodiments, for example, the welded connections may be intended to hold an assembly together until an adhesive bond is cured or completed.

A practice of the invention has been illustrated in the embodiment of assembling automotive vehicle bodies but the method may be used to provide resistance welded connections in other applications using assembled polymeric (with metallic welding inserts) and metal components.

Other advantages of the invention will be apparent from a further description of preferred embodiments which follows.

### BRIEF DESCRIPTION OF THE DRAWINGS

FIG. 1 illustrates representative shapes of a stamped metal inner door panel and a reinforced polymer outer door panel that are in a juxtaposed position just prior to being brought together for a combination of resistance welding and adhesive bonding. A bead of adhesive has been applied to the attachment surface of the metal panel.

FIG. 2 is a cross-sectional view at 2-2 of the outer reinforced polymer panel of FIG. 1 illustrating a molded in situ weld insert body to enable electrical resistance welding of the polymer panel to the metal panel.

FIG. 3 is a cross-sectional view at 2-2 of FIG. 1 showing the outer reinforced polymer panel placed against the metal panel with resistance welding electrodes positioned and forming a welded bond.

FIG. 4 is an oblique view of a welding insert of the type used in the reinforced panel illustrated in FIGS. 2 and 3.

### DESCRIPTION OF PREFERRED EMBODIMENTS

In accordance with one embodiment of the invention, a fiber reinforced body panel is spot welded and adhesively bonded to a steel inner door panel in the manufacture of a door structure of an automotive vehicle. The method of preparing and joining the door panels will be described with reference to the drawing figures.

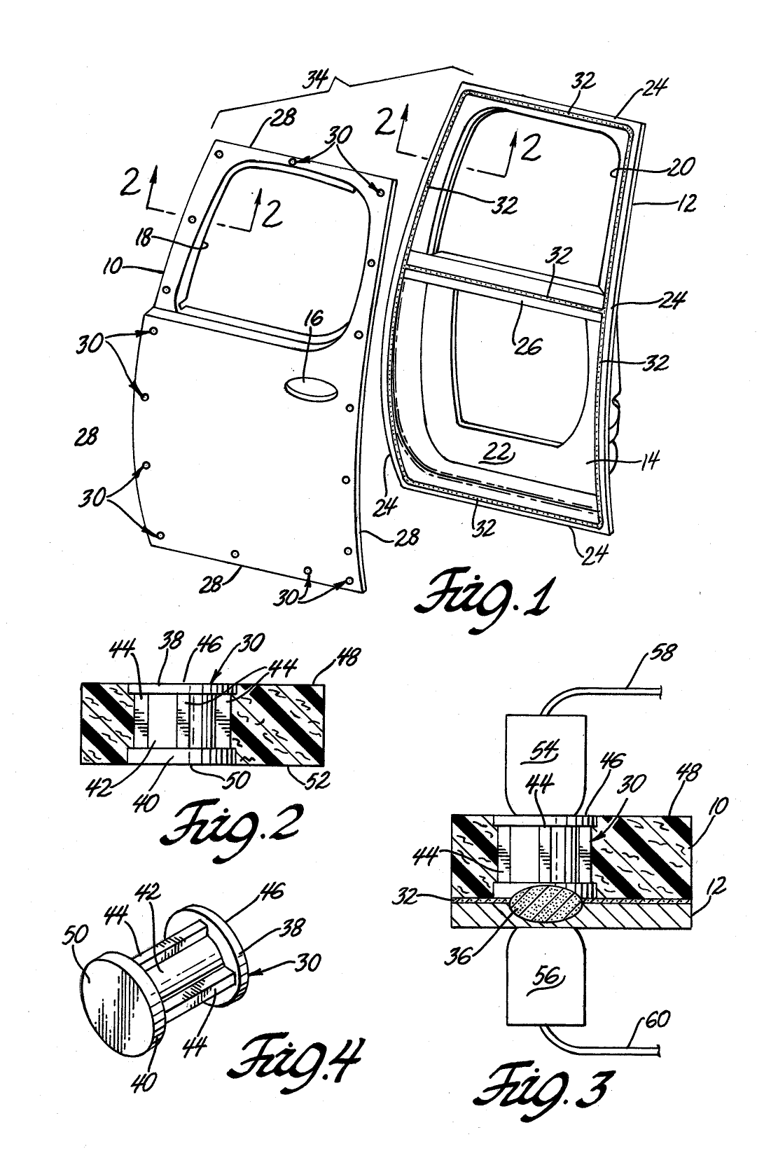

In FIG. 1, a glass fiber reinforced polymer matrix outer panel 10 is seen positioned with its inner side (not visible in the figure) facing the inner side 14 of a low carbon steel alloy (or other suitable metal alloy such as a formable aluminum alloy) inner panel 12. Reinforced polymer outer panel 10 has been molded to have the top to bottom curvature of the side of a vehicle, a formed region 16 for a handle for opening and closing the door, and a framed-in window opening 18. Inner panel 12 has been stamped from blank metal sheet material to complement the shape of outer panel 10. Inner panel 12 is shaped to define its corresponding window opening 20 and to provide a compartment (indicated generally at 22) for containing a mechanism for opening and closing a window and other components to be fitted within the bonded door panel assembly.

As best seen on the inner side 14 of inner panel 12 each stamping has peripheral surfaces 24 (on inner panel 12) and a belt line surface 26 for bonding to the facing side of the mating panel. Outer panel 10 likewise has peripheral flange edges 28. Molded into the peripheral edges 28 of fiber reinforced outer panel 10 are a suitable predetermined number (17 in FIG. 1) of metal inserts 30 for forming electrical resistance spot welds between outer door panel 10 and inner panel 12. Metal inserts provide a conductive path from the outer surface of outer panel 10 through panel 10 and to a touching surface on peripheral surface 24 of metal inner panel 12 for making the electrical resistance welds. Metal inserts 30 also provide weld metal for the fused weld junctions. In some practices of the invention, the spot welds may provide the sole points of attachment between the panels and, in other embodiments, the spot welds may be used to fix the panels together until an adhesive bond has been cured.

In the adhesive bonding of these complementary inner and outer panels 10, 12 strips or bands of adhesive 32 are applied in a suitable pattern to surfaces 24 and 26 on inner surface 14 of inner panel 12. The outer panel 10 is then aligned against inner panel 12 in an assembly 34 with like peripheral and beltline surfaces of the inner side of the outer panel 10 pressed against the applied adhesive strips 32 on inner panel 12.

FIG. 2 is a cross-sectional view taken at location 2-2 of a window frame portion of outer panel 10 in FIG. 1 showing a portion of the molded door panel with one of the molded-in metal inserts 30. FIG. 3 is a cross-sectional view taken at locations 2-2 showing the interface between facing panels 10, 12 with an interfacial layer of adhesive 32 and a spot weld nugget 36 formed between metal insert 30 and inner panel 12. The thicknesses of the cross-sectional views are enlarged for purposes of illustration. FIG. 4 is an oblique view of a single metal insert 30 and this figure, too, is enlarged.

Referring to FIG. 2 and FIG. 4, metal insert 30 is a generally cylindrical body with opposing round, flat end sections 38, 40 connected by a round cylindrical body 42. Extending radially from round body 42 are four longitudinal ribs 44 equi-spaced around the circumference of body 42. Metal inserts 30 are sized for the molding into which they are incorporated. In the embodiment of the invention depicted in these figures, planar surface 46 of end section 38 of metal insert 30 lies co-planer with a surface 48 of molded panel 10, and surface 50 of end section 40 lies co-planar with surface 52 of molded panel 10. The end portions of a metal insert are often alike so that it can be molded into a polymer component without regard to which end is up.

The insert 30 may be coated, for example, with a particulate ceramic coating to reduce the transfer of welding heat to the surrounding polymeric material in panel 10 or other workpiece. The coating is not illustrated in FIG. 2-4 but would be applied to a desired thickness for its insulating function.

The areas of metal insert surfaces 46, 50 are sized to provide for contact with a mating surface and with an electrical resistance welding electrode. For example, surface area 46 is sized to accommodate generally central contact by the welding electrode with additional lateral surface space from the adjoining polymeric material. End-sections 38, 40 are sized to contribute weld metal to a weld nugget connecting molded-in weld insert 30 to a metal panel or other component. The body 42 is sized for strength and to conduct a welding current from on end section 38 to the other 40. Ribs 44 are used when it is desired to anchor insert 30 against rotation or other movement in the molded part. While longitudinal ribs 44 are illustrated in FIGS. 2-4 as anchoring members for insert 30 other anchoring shapes (if any are used) may be employed. For example, one or more circumferential ribs (not illustrated) may be provided along the longitudinal axis of insert 30 to resist tearing of the insert 30 from its matrix polymeric material.

In FIGS. 2 and 3, surfaces 46, 50 of metal insert 30 are shown as co-planar with surfaces 48, 52 of molded panel 10. This embodiment provides good contact with a metal part to be attached and with a welding electrode. However, it is appreciated that the surfaces of the metal welding insert may lie slightly above or below the surfaces of the polymeric molding in which it is inserted. And, as stated above, it is preferred that the surfaces be large enough for easy contact by a welding electrode and to minimize flaring of the edges of the surface during welding.

In FIG. 3, molded panel 10 is shown pressed against adhesive layer 32 on metal panel 12 in a position for forming a spot weld. Opposing copper welding electrodes 54, 56 with their electrical leads 58, 60 are pressing against the outer surfaces of the assembled parts. Pressure between electrodes 54, 56 would displace adhesive from the interface between metal insert 30 and metal part 12. The illustration of FIG. 3 shows the assembled parts 10, 12 just after an impulse of welding current has been passed from surface 46 of metal insert through the body and opposing end of the insert and through metal part 12. As heat is dissipated into the parts and ambient, a solid weld nugget 36 forms.

By way of example, the thicknesses of panels 10, 12 is often in the range of about one to two millimeters and the thickness of the cured or hardened adhesive layer 32 is, nominally, less than one millimeter. A sufficient number of spot welds are formed progressively around the periphery of the assembled panels to obtain a suitable joined assembly.

In a preferred embodiment, the contacted end sections 38, 40 of metal insert 30 were round because a typical electrical resistance spot welding electrode has a round welding face. However, it is to be understood that the contacting surfaces of the metal insert may be square, elliptical, or of any desired useful shape. The surface area is to provide for a weld nugget of suitable strength and an electrode contacting surface for producing the nugget. Further, the insert may have an elongated rectangular shape where it is desired to form a seam weld using the insert or a stitch seam weld using more than one elongated metal inserts.

A practice of the invention has been described using a glass fiber reinforced polymer compositions but other reinforcing materials and other non-conducting polymers may be used. The invention is also applicable to welding non-reinforced polymer compositions to spot weld able surfaces.

The invention may be used to weld polymer parts to metal parts in many vehicle body building operations and in other article manufacturing applications.

Thus, the invention has been illustrated by descriptions of some preferred embodiments but these illustrations are not intended to limit the scope of the invention.

1. A method of making a weld between facing surfaces of welding attachment portions of a metal workpiece and a molded polymeric workpiece, the attachment portions of the metallic workpiece and the polymeric workpiece each having first and second opposing surfaces where the workpieces are to be attached at the respective first surfaces of their attachment portions, the method comprising:
molding at least one metallic welding insert into an attachment portion of a polymeric workpiece at an intended weld site, the metallic welding insert having a welding surface at each of the first and second surfaces of the attachment portion of the polymeric workpiece and a body portion interconnecting the welding surfaces of the metallic insert,
assembling the metal workpiece and polymeric workpiece with the first surfaces of their attachment portions contacting for the formation of an electrical resistance spot weld at the weld site;
pressing a welding electrode against a welding surface of the molded-in metallic welding insert and an opposing welding electrode against the second surface of the metallic workpiece opposite the welding insert;
passing a momentary welding current between the opposing electrodes, through the welding insert and contacting attachment portion of the metal workpiece to produce a pool of fused metal from the contacting surfaces of the metal insert and metal workpiece; and
permitting the fused metal to cool and re-solidify to form a weld nugget joining the polymeric workpiece and the metal workpiece.

2. A method of making a weld as recited in claim 1 in which the welding surfaces of the metal welding insert are shaped for a spot weld.

3. A method of making a weld as recited in claim 1 in which the welding surfaces of the metal welding insert are shaped for a linear seam weld.

4. A method of making a weld as recited in claim 1 in which composition of the metal workpiece and the composition of the metal welding insert are each formed of an alloy of the same base metal.

5. A method of making a weld as recited in claim 1 in which the welding surfaces of the metallic welding insert are of the same shape and area.

6. A method of making a weld as recited in claim 1 in which the welding surfaces of the metallic welding insert are both round and have the same area.

7. A method of making a weld as recited in claim 1 in which the body of the metallic welding insert is shaped with anchoring elements for anchoring in the polymeric material in which the insert is molded.

8. A method of making a weld as recited in claim 1 in which the polymeric workpiece is an automotive vehicle body panel.

9. A method of making a weld as recited in claim 1 in which the polymeric workpiece is an automotive vehicle body component and the metallic workpiece is a complementary vehicle body component.

10. A method of making a weld as recited in claim 1 in which the polymeric workpiece is an automotive vehicle body panel and the metallic workpiece is a body panel or a vehicle frame member.

11. A method of making a spot weld between facing surfaces of welding attachment portions of a metal workpiece and a molded polymeric automotive vehicle body panel, the attachment portions of the metallic workpiece and the polymeric body panel each having first and second opposing surfaces where the workpieces are to be attached at the respective first surfaces of their attachment portions, the method comprising:
molding at least one metallic welding insert into an attachment portion of the polymeric body panel at an intended weld site, the metallic welding insert having a welding surface at each of the first and second surfaces of the attachment portion of the polymeric panel and a body portion interconnecting the welding surfaces of the metallic insert,
assembling the metal workpiece and polymeric body panel with the first surfaces of their attachment portions contacting for the formation of an electrical resistance spot weld at the weld site;
pressing a spot welding electrode against a welding surface of the molded-in metallic welding insert and an opposing spot welding electrode against the second surface of the metallic workpiece opposite the welding insert;
passing a momentary welding current between the opposing electrodes, through the welding insert and contacting attachment portion of the metal workpiece to produce a pool of fused metal from the contacting surfaces of the metal insert and metal workpiece; and
permitting the fused metal to cool and re-solidify to form a weld nugget joining the polymeric workpiece and the metal workpiece.

12. A method of making a spot weld as recited in claim 11 in which composition of the metal workpiece and the composition of the metal welding insert are each formed of an alloy of same base metal.

13. A method of making a spot weld as recited in claim 11 in which the welding surfaces of the metallic welding insert are of the same shape and area.

14. A method of making a spot weld as recited in claim 11 in which the welding surfaces of the metallic welding insert are both round and have the same area.

15. A method of making a spot weld as recited in claim 11 in which the body of the metallic welding insert is shaped for anchoring in the polymeric material in which it is molded.

16. A method of making a spot weld as recited in claim 11 in which the metallic workpiece is a complementary vehicle body panel.

17. A method of making a spot weld as recited in claim 11 in which the metallic workpiece is a body frame member.

18. A method of making a spot weld as recited in claim 11 in which the metallic workpiece is an underbody member.
